(19) United States
(12) Patent Application Publication
(10) Pub. No.: US 2012/0018088 A1
(43) Pub. Date: Jan. 26, 2012

(54) METHOD FOR CONNECTING ELECTRODES AND BONDING COMPOSITION USED THEREFOR

(75) Inventor: Chunfu Chen, Kawasaki (JP)

(73) Assignee: Henkel Corporation, Rocky Hill, CT (US)

(21) Appl. No.: 13/213,342

(22) Filed: Aug. 19, 2011

Related U.S. Application Data
(63) Continuation of application No. PCT/JP2010/052545, filed on Feb. 19, 2010.

(30) Foreign Application Priority Data
Feb. 20, 2009 (JP) 2009-038381

(51) Int. Cl. B32B 37/14; C09J 175/16

(52) U.S. Cl. 156/275.5; 522/96

(57) ABSTRACT

There is disclosed a method for adhering a first connecting portion comprising a first electrode formed on a transparent substrate and a second connecting portion comprising a second electrode formed on a flexible substrate, whereby electrically connecting the first electrode and the second electrode, the method comprising the steps of: applying a bonding composition on at least one of the first connecting portion and the second connecting portion; aligning the first electrode and the second electrode, and irradiating with light while the first connecting portion and the second connecting portion are pressed so as to contact each other; and allowing the resulting assembly to stand at ambient temperature after the light irradiation; wherein the bonding composition comprises no electrically-conductive particle, but comprises: (a) a curable resin component; (b) a photo cure initiation component; and (c) an anaerobic curing initiation component; and wherein the anaerobic curing is not completed when the photo-irradiation is terminated.

### TECHNICAL FIELD

The present invention relates to a method for manufacturing flat displays such as liquid crystal display panels, and in more details a method for connecting the electrode of the flat display and the electrode of a flexible substrate and a material to connect them.

### BACKGROUND

Flat displays such as liquid crystal displays (LCDs), organic EL displays and plasma displays have transparent electrodes such as ITO (indium tin oxide), IZO (indium zinc oxide) and SnO₂ formed on a glass substrate, and they are generally connected to an external driving circuit through a flexible substrate at a peripheral lead-in/out electrode portion.

For connecting the transparent electrode and the electrode on the flexible substrate, an anisotropic electrically-conductive film comprising electrically-conductive particles is used. The anisotropic electrically-conductive film is placed between the upper and lower electrodes (i.e. the transparent electrode and the electrode on the flexible substrate) at an aligned position and pressed with heating, whereby electrical connection is established in an vertical direction whereas lateral insulation is maintained.

However, with the development of high definition flat displays in recent years, the pitch of the transparent electrodes have become finer and the size of the electrically-conductive particles is no more negligible in comparison with the line space. The risk of electrical short circuit has increased due to the gathering of relatively small number of electrically-conductive particles. Consequently, ensuring lateral insulation (i.e. between the transparent electrodes, between the electrodes on the flexible substrate) and the reliability in insulation is a problem to be solved.

JP-A-H7-302973 (Patent document 1) and JP-A-H7-106369 (Patent document 2) describe that the electrode on one substrate (the flexible substrate and the like) and the electrode on another substrate are pressed to contact each other, wherein a photo-curable adhesive resin having volume-shrinkage function is filled between these substrates, followed by ultraviolet-light curing; and the volume-shrinkage force enhances the connection between the electrodes.

Since no anisotropic electrically-conductive film is used, the method using these photo-curable adhesive resins raises no problem of decrease in lateral insulation. However, the transparent electrode of the flat display has frequently, except for pixels, a non-transparent metal layer in line parts and/or lead-in/out electrode portion, or the transparent electrode of thicker film may be used in order to reduce electrical resistance. Therefore, sufficient amount of UV light does not reach shades of electrodes. Even if the irradiation with UV light is attempted from the side of the flexible substrate, UV light does not reach shades of electrodes, because they are generally made of copper. In addition, polyimide, which is frequently used as a substrate film, does not transmit the light in a range of ultraviolet. Consequently, necessary adhesive strength is not achieved and there are problems in insufficiency of the adhesive strength. In particular, this is a serious problem when the connecting portion includes both group of electrodes with fine pitch and an electrode with wider width.

JP-A-H10-13000 (Patent document 3) also describes the method for connecting electronic parts to a circuit board with ultraviolet-curing-combined anaerobic adhesive. However, the used adhesive composition comprises electrically-conductive particles, and therefore, it cannot be applied to the fine pitch. Furthermore, this method utilizes primarily the anaerobic adhesive function and the irradiation with ultraviolet light is conducted after heating (150° C.) with pressing. If this method is applied to a flexible substrate, the displacement of pitch in alignment may easily occur because of elongation of film caused by heat.

JP-A-H6-168621 (Patent document 4) also describes the method for achieving electrical connection between ceramic elements and a metal board with ultraviolet-curing-combined anaerobic adhesive. However, this method also utilizes the anaerobic adhesive function, and specifically, the adhesion is conducted by applying pressure at 25 to 60° C., and the irradiation with ultraviolet light is then performed in order just to cure the adhesive that has been squeezed out. Therefore, the ultraviolet-curing adhesive function is not really involved in the connection of the ceramic elements and the metal board.

### REFERENCES OF PRIOR ART

### Patent Documents

Patent document 1: JP-A-H7-302973. Patent document 2: JP-A-H7-106369 (JP Patent 3031134). Patent document 3: JP-A-H10-13000. Patent document 4: JP-A-H6-168621 (JP Patent 3417964)

### SUMMARY OF THE INVENTION

The present invention was accomplished in view of the aforementioned conventional problems, and its objective is to provide the method for connecting electrodes by a simple process with excellent adhesive property and reliability even for the connection in the fine pitch, and to provide the resin composition suitable for the connection.

The present invention relates to the following items.

1. A method for adhering of a first connecting portion comprising a first electrode formed on a transparent substrate and a second connecting portion comprising a second electrode formed on a flexible substrate, whereby electrically connecting the first electrode and the second electrode, the method comprising the steps of:

applying a bonding composition on at least one of the first connecting portion and the second connecting portion;

aligning the first electrode and the second electrode, and irradiating with light while the first connecting portion and the second connecting portion are pressed so as to contact each other; and

allowing the resulting assembly to stand at ambient temperature after the light irradiation; wherein

the bonding composition comprises no electrically-conductive particle, but comprises:

(a) a curable resin component;

(b) a photo cure initiation component; and

(c) an anaerobic curing initiation component;

and wherein the anaerobic curing is not completed when the photo-irradiation is terminated.
2. A method according to the above item 1, wherein the photo cure initiation component (b) is a photo radical generator.
3. A method according to the above item 1, wherein the photo-irradiation comprises a wavelength of a visible light range, and the photo cure initiation component (b) comprises a visible-light-radical generator which generates a radical by a photo-irradiation of a visible light range.
4. A method according to the above item 3, wherein the photo-irradiation comprises a wavelength of a visible light range from 400 to 550 nm, and the photo cure initiation component (b) comprises a visible-light radical generator which generates a radical by a photo-irradiation of this range of wavelength.
5. A method according to any one of the above items 1 to 4, wherein the curable resin component (a) comprises a (meth)acrylic monomer and/or a (meth)acrylate oligomer.
6. A bonding composition used for the method according to any one of the above items 1 to 5, wherein the bonding composition comprises no electrically-conductive particle, but comprises:

(a) a curable resin component;

(b) a photo cure initiation component; and

(c) an anaerobic curing initiation component;

wherein the bonding composition is prepared so that a anaerobic curing time is longer than a photo-curing time.

### EFFECT OF THE INVENTION

The present invention can provide the method for connecting electrodes by a simple process with excellent adhesive property and reliability even for the connection in the fine pitch, and can provide the resin composition suitable for the connection.

### BRIEF DESCRIPTION OF THE DRAWINGS

FIG. 1 is a view schematically showing the manner in which the first electrode and the second electrode are electrically connected and adhered.

### MODE FOR CARRYING OUT THE INVENTION

The present invention is the method for adhering a first connecting portion comprising a first electrode formed on a transparent substrate to a second connecting portion comprising a second electrode formed on a flexible substrate, and simultaneously electrically connecting the first electrode to the second electrode.

The transparent substrate is not restricted, but it may be a substrate composing a flat display such as liquid crystal displays, organic EL displays and plasma displays, and is, for example, an insulating substrate such as a glass substrate and a transparent film substrate, in particular, a glass substrate. A first connecting portion exists on the transparent substrate, which comprises a first electrode for electrical connection with an external circuit (specifically, a second electrode on a flexible substrate) and achieves electrical connection and mechanical adhesion with the flexible substrate. The first electrode is composed of transparent electrically-conductive material such as ITO (indium tin oxide), IZO (indium zinc oxide) and SnO₂, metal such as Ag, Cu, Au, Al, Mo, W, Cr, Ti and Nd, alloy containing at least one of these metals (Al alloy such as Al—Nd, Cu alloy such as Cu—Mn, and the like), multi-layer structure of these materials, or the like. In case of the multi-layer structure, two or more materials do not necessarily have the equal line-width. For example, the electrode may be of the structure in which the transparent electrically-conductive material such as ITO and IZO covers the upper surface and side surface of wiring made of metal (including alloy) such as Mo formed on a substrate.

The flexible substrate is not restricted, but it may be, for example, an insulating polymer film such as polyimide and polyethylene terephthalate, in general, polyimide film is frequently used. A second connecting portion exists on the flexible substrate, which comprises a second electrode for electrical connection with the wiring of a flat display (specifically, the first electrode on the transparent substrate) and achieves electrical connection and mechanical adhesion with the transparent substrate. The second electrode is generally formed of Cu. The thickness of Cu is not restricted, but it may be not more than about several tens of μm, for example, 1 to 20 μm, furthermore the thickness of 1 to 10 μm and the like.

The first electrode and the second electrode usually compose groups of plurality of electrodes. Their pitch is not particularly restricted, and they may have different pitches and widths in the group of electrodes. Usually, even if the narrowest pitch in the group of electrodes is, for example, 10 μm to 200 μm, further 100 μm or less, in particular 50 μm or less, the electrical connection of the first electrode and the second electrode can be established with excellent reliability without damaging the insulation between the electrodes on the same substrate (between the first electrode each, between the second electrode each) according to the present invention.

In the first step according to the present invention, the bonding composition is applied on at least one of the first connecting portion and the second connecting portion. The materials of the bonding composition are described later. Its application method is not particularly restricted, and a common application method, for example, application by a dispenser, screen printing or the like may be utilized.

Next, the first electrode on the transparent substrate and the second electrode on the flexible substrate are placed so that they are opposed to each other, and the positions of the first electrode and the second electrode are aligned, and then the first connecting portion and the second connecting are pressed and attached to each other. At the time, sufficient pressure is applied so that the first electrode and the second electrode are in contact.

Next, while this state is maintained, the junction part (hereafter, the part where the first connecting portion and the second connecting portion are joined is referred to as the junction part) is irradiated with light. The light preferably has wavelength in the region of ultraviolet light and/or visible light, in particular preferably comprises the light in the visible light region, and may comprise the light in only the visible light region, but more preferably the light covers the region from ultraviolet light to visible light. When adverse effect on liquid crystal materials and the like causes problems, the junction part may be irradiated only with the visible light region. When the irradiation through the transparent substrate is attempted and the transmittance of the electrode on the transparent substrate for the ultraviolet light region is low, the photo-curing is still possible if the visible light region is included. Furthermore, when the irradiation through the flexible substrate is attempted, the photo-curing with the light comprising the visible light is also preferred because commonly-used polyimide does not transmit the ultraviolet light. The irradiation with light may be possible through the transparent substrate or through the flexible substrate. Further, the irradiation from both sides is also preferred.

Although the photo-irradiation time per one portion (i.e., the time the bonding composition receives the light) may be arbitrarily selected depending on a process, the time is generally not longer than about 30 seconds, more preferably not longer than about 10 seconds, and generally not shorter than about 0.5 seconds due to certainty of the irradiation, for example, not shorter than about 1 second.

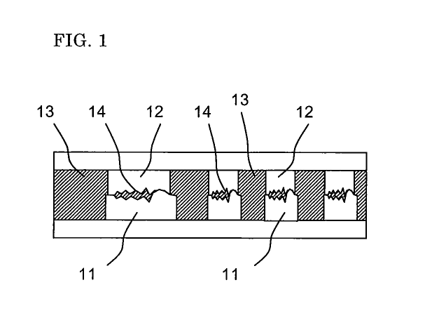

The photo-irradiation cures most of the bonding composition at the junction part. However, since sufficient amount of UV light does not reach the shades of the first electrode and/or the second electrode, the composition is not sufficiently cured. Whereas the first electrode and the second electrode contact each other and achieve electrical conduction, they are not completely flat in microscopical view, and often convex-concave structure or inlay structure may be provided to the electrodes. As schematically shown in FIG. 1, the cured resin 13 exists at the position where the first electrode 11 and the second electrode 12 does not exist. Whereas, the uncured or insufficiently-cured resin 14 remains between the first electrode and the second electrode, and the adhesive strength between the first electrode and the second electrode may become insufficient. Depending on its components, the uncured bonding composition may also corrode the electrodes.

However, the bonding composition to be used in the present invention has anaerobic curing capability, and the curing of the composition proceeds over time passage after the light irradiation, leading to the final curing. Therefore, no composition remains as uncured in the present invention, and strong adhesive strength is obtained even between the first electrode and the second electrode. The anaerobic curing of the bonding composition to be used in the present invention possesses requires longer time than that of the photo-curing. That is to say, the photo-curing according to the present invention achieves initial and substantial curing, and the anaerobic curing increases reliability. If the anaerobic curing occurs too early, the positional relationship between the first electrode and the second electrode may be fixed before the irradiation of light, which may aversely block the electrical connection.

Therefore, the anaerobic curing should not be completed at least when the photo-irradiation is terminated, and the time required for the completion is, for example, not shorter than 1 minute, preferably not shorter than 5 minutes, more preferably not shorter than 10 minutes and may require 1 hour or longer, for example, about 24 hours.

In the present invention, the anaerobic curing is completed by, for example, allowing it to stand at ambient temperature after the light irradiation. Post-assembling may be conducted immediately after the photo-irradiation unless excessive force is applied at the junction part.

### Bonding Composition

The bonding composition to be used for the method according to the present invention is explained. This composition comprises no electrically-conductive particle, but comprises:

(a) a curable resin component;

(b) a photo cure initiation component; and

(c) an anaerobic curing initiation component.

Furthermore, the composition has such a formulation that the anaerobic curing is not completed until the photo-irradiation is terminated.

The (a) curable resin component is the component curable by photo-curing and by anaerobic curing.

The curable resin component (a) is the monomer or oligomer having polymerizable double bond. In particular, the (meth)acrylic monomers or (meth)acrylate oligomers having CH₂═CHR—C(O)— (in which R is H or CH₃) are preferable, especially those bonded in a form of ester are preferable. Although either monofunctional ones having only one double bond or polyfunctional ones having a plurality of double bonds may be used, it is preferable to contain polyfunctional monomers or oligomers.

Monofunctional (meth)acrylic monomers include, for example, (meth)acrylic acid, butanediol mono(meth)acrylate, cyclohexyl (meth)acrylate, dicyclopentanyl (meth)acrylate, dicyclopentenyl (meth)acrylate, dicyclopentenyloxyethyl (meth)acrylate, N,N-diethylaminoethyl (meth)acrylate, 2-ethoxyethyl (meth)acrylate, 2-hydroxyethyl (meth)acrylate, 2-hydroxypropyl (meth) acrylate, caprolactone-modified2-hydroxyethyl (meth)acrylate, isobornyl (meth)acrylate, lauryl (meth)acrylate, acryloylmorpholine, N-vinylcaprolactam, nonylphenoxypolyethylene glycol (meth)acrylate, nonylphenoxypolypropylene glycol (meth)acrylate, phenoxyethyl (meth)acrylate, phenoxyhydroxypropyl (meth)acrylate, phenoxydiethylene glycol (meth)acrylate, polyethylene glycol (meth)acrylate, polypropylene glycol (meth)acrylate, tetrahydrofurfuryl (meth)acrylate and the like.

Polyfunctional (meth)acrylic monomers include, for example, 1,4-butanediol di(meth)acrylate, dicyclopentanyl di(meth)acrylate, ethylene glycol di(meth)acrylate, dipentaerythritol hexa(meth)acrylate, caprolactone-modified dipentaerythritol hexa(meth)acrylate, 1,6-hexanediol di(meth)acrylate, neopentyl glycol di(meth)acrylate, pentaerythritol tri(meth)acrylate, polyethylene glycol di(meth)acrylate, polypropylene glycol di(meth)acrylate, tetraethylene glycol di(meth)acrylate, trimethylolpropane tri(meth)acrylate, tris(acryloxyethyl)isocyanurate, caprolactone-modified tris(acryloxyethyl)isocyanurate, tris(methacryloxyethyl)isocyanurate, tricyclodecane dimethanol di(meth)acrylate and the like.

These monofunctional (meth)acrylic monomers and polyfunctional (meth)acrylic monomers may be used alone or in combination with 2 or more monomers, or may be used in combination with the monofunctional and polyfunctional monomers.

Furthermore, the (meth)acrylic oligomers are those having at least one (meth)acryloyl group, and they include, for example, epoxy acrylate (having a bond of opened epoxy group in its structure), urethane acrylate (having a urethane bond in its structure), polyester acrylate (having a ester bond in its structure), polybutadiene acrylate (having a polybutadiene bond in its structure), polyol acrylate, polyether acrylate (having a polyether bond in its structure), silicone resin acrylate, melamine acrylate, and the like. Although these are preferably di(meth)acrylate ester, monofunctional (meth)acrylate ester may be also used.

Since it is preferable that the finally-cured composition has resistance against peeling, the composition preferably has flexibility at a certain level. Therefore, it is preferable that relatively soft (meth)acrylate oligomers, i.e., those comprising a flexible part in the molecules are contained. Specifically, it is preferable that (meth)acrylate oligomer such as urethane acrylate, polyester acrylate and polybutadiene acrylate is contained, and in particular urethane acrylate is preferable.

Urethane acrylate has a structure where, for example, (meth)acrylate is introduced at the terminal of the urethane structure obtained by a reaction of polyisocyanate with polyol or polyamine, and known those may be used.

Since photo-curing rate is prioritize in the present invention, it is preferable that acrylate monomer and/or acrylate oligomer is contained in higher ratio than the ratio of methacrylate monomer and/or methacrylate oligomer.

It is also preferable that the curable resin component is composed of two or more constituents selected from (meth)acrylate monomers and (meth)acrylate oligomers. It is particularly preferable to use oligomer such as urethane acrylate and the monomer which comprises a functional group improving adhesion such as hydroxy group and carboxylic acid group in combination.

It is also preferable that 50% or more (weight-basis) of polyfunctional (meth)acrylate monomers or oligomers are contained in the curable resin component.

The photo cure initiation component (b) is a photo-radical initiator, and it may be a compound that generates radical by irradiation with ultraviolet light or visible light.

The ultraviolet-light-radical initiator may include acetophenone-based initiator such as diethoxyacetophenone and benzyl dimethyl ketal, benzoin ether-based initiator such as benzoin and benzoin ethyl ether, benzophenone-based initiator such as benzophenone and methyl o-benzoylbenzoate, α-diketone-based initiator such as butanedione, benzyl and aceto naphthophenone, and thio compound such as methylthioxanthone.

The visible-light-radical initiator may include camphoroquinone-based compound such as camphoroquinone, 7,7-dimethyl-2,3-dioxobicyclo[2.2.1]heptane-1-carboxylic acid, 7,7-dimethyl-2,3-dioxobicyclo[2.2.1]heptane-1-carboxy-2-bromo ethyl ester, 7,7-dimethyl-2,3-dioxobicyclo[2.2.1]heptane-1-carboxy-2-methyl ester and 7,7-dimethyl-2,3-dioxobicyclo[2.2.1]heptane-1-carboxylic acid chloride, acylphosphine oxide-based compound such as benzoyldiphenylphosphine oxide, 2,6-dimethylbenzoyldiphenylphosphine oxide, 2,4,6-trimethylbenzoyldiphenylphosphine oxide, benzoyldiethoxyphosphine oxide, 2,4,6-trimethylbenzoyldimethoxyphenylphosphine oxide, 2,4,6-trimethylbenzoyldiethoxyphenylphosphine oxide and bis(2,4,6-trimethylbenzoyl)phenylphosphine oxide, and the like.

In the present invention, it is preferable that the photo cure initiation component particularly comprises the visible-light-radical initiator. A sensitizer may be also used if needed, and it may be the sensitizer that enables the visible-light-radical initiation by using in combination with an initiator even though the initiator is usually classified as the ultraviolet-light-radical initiator. Herein, the visible-light-radical initiator absorbs light in a range from 380 nm to 780 nm, preferably light in a range from 400 nm to 550 nm, and generates radical which contributes to polymerization.

As the sensitizer, known compounds may be used. Typically, the examples of amine-based compounds include primary amine compounds such as n-butylamine, n-hexylamine, n-octylamine and aniline; secondary amine compounds such as N-methylaniline, N-methyl-p-toluidine, dibutylamine and diphenylamine; and tertiary amine compounds such as triethylamine, tributylamine, N,N′-dimethylaniline, N,N′-dibenzylaniline, N,N′-dimethylaminoethyl methacrylate, p-dimethylaminobenzoic acid, amyl p-dimethylaminobenzoate, ethyl p-dimethylaminobenzoate, N,N′-dimethylanthranic acid methyl ester, p-dimethylaminophenethyl alcohol, N,N′-di(β-hydroxyethyl)-p-toluidine, N,N′-dimethyl-p-toluidine and N,N′-diethyl-p-toluidine. The (meth)acrylic acid ester of alkanolamines such as dimethylaminoethyl methacrylate may also be used.

Among these amine compounds, in considering easiness of handling, their odor and the like, it is preferred to use the tertiary amine compounds, in particular, the tertiary amine compounds in which their amino group is directly linked to a benzene ring such as p-dimethylaminobenzoic acid, and its esters (preferably alkyl esters having 1 to 20 carbon atoms), N,N′-di(β-hydroxyethyl)-p-toluidine and N,N′-dimethyl-p-toluidine. The amine compound may be used alone, or in combination of 2 or more compounds.

A plurality of the photo-radical initiators may be used in combination. For example, the ultraviolet-light-radical initiator and the visible-light-radical initiator may used in combination, which enables to expand the possible wavelength region for curing. The photo cure initiation component is blended so that the curable resin component can be cured for a light-irradiation time preferably not longer than about 30 seconds, more preferably not longer than 10 seconds. The curable resin component (a) is also selected so that it can be cured for this time.

For the anaerobic curing initiation component (c), known systems comprising organic peroxide and promoter may be used.

The organic peroxide is those which have been conventionally used for anaerobic curable compositions, and it is not restricted specifically and includes, for example, hydroperoxides such as cumene hydroperoxide, t-butylhydroperoxide, p-methane hydroperoxide, methyl ethyl ketone peroxide, cyclohexane peroxide, dicumylperoxide and diisopropylbenzene hydroperoxide, other organic peroxides such as ketone peroxides, diallylperoxides and peroxyesters, and the like.

The promoter is those which have been conventionally used for anaerobic curable compositions, and though it is not restricted specifically, it includes o-benzoic sulfimide (saccharin), hydrazine compound, amine compound and mercaptan compound. The amine compound includes heterocyclic secondary amine such as 1,2,3,4-tetrahydroquinoline and 1,2,3,4-tetrahydroquinaldine, heterocyclic tertiary amine such as quinoline, methylquinoline, chinaldine, quinoxaline and phenazine, aromatic tertiary amine such as N,N-dimethyl-anisidine and N,N-dimethylaniline, azole-based compound such as 1,2,4-triazole, oxazole, oxadiazole, thiadiazole, benzotriazole, hydroxybenzotriazole, benzoxazole, 1,2,3-benzothiadiazole and 3-mercaptobenzotriazole, and the like.

The hydrazine compound includes 1-acetyl-2-phenylhydrazine, 1-acetyl-2-(p-tolyl)hydrazine, 1-benzoyl-2-phenylhydrazine, 1-(1′,1′,1′-trifluoro)acetyl-2-phenylhydrazine, 1,5-diphenylcarbohydrazine, 1-formyl-2-phenylhydrazine, 1-acetyl-2-(p-bromophenyl)hydrazine, 1-acetyl-2-(p-nitrophenyl)hydrazine, 1-acetyl-2-(p-methoxyphenyl)hydrazine, 1-acetyl-2-(2′-phenylethyl)hydrazine, 1-acetyl-2-methylhydrazine, 1-phenylsemicarbazide, 2-phenyl-t-butylcarbazate, di(phenylhydrazide) succinate, and the like.

The mercaptan compound includes straight-chain mercaptans such as n-dodecylmercaptan, ethylmercaptan and butylmercaptan, and the like.

Two or more promoters may be used in combination, and they include, for example, combination of saccharin and the amine compound and combination of saccharin and the hydrazine compound.

In terms of the anaerobic curing in the present invention, the anaerobic curing occurs by decomposition of the peroxide through the redox reaction involving the promoter and transition metal ion because the electrode existing at a junction area contains transition metal components such as Cu.

The anaerobic curing component is blended so that the curing is completed for a duration longer than the photo-irradiation time when the curable resin component (a) is cured only with the anaerobic curing function in the absence of light irradiation, and the anaerobic curing time is, for example, not shorter than 1 minute, preferably not shorter than 5 minutes, more preferably not shorter than 10 minutes and may require 1 hour or longer, for example, about 24 hours.

The photo cure initiation component and the anaerobic curing initiation component in the bonding composition of the present invention are preferably formulated such that the photo cure initiation has priority.

The bonding composition may further comprise additive, resin component and the like to improve or modify properties such as flowability, applying property, preserving property, curing property and physical property after curing.

The component that may be contained as needed includes, for example, silane coupling agent, diluent, modifier, surfactant, preservative-stabilizer, defoamer, leveling agent and the like; however it is not limited to these.

The silane coupling agent includes, without particular limitation, γ-aminopropyltriethoxysilan, γ-mercaptopropyltrimethoxysilan, γ-methacryloxypropyltrimethoxysilan, γ-glycidoxypropyltrimethoxylsilan, SH6062, SZ6030 (above all, Toray-Dow Corning Silicone Inc.), KBE903, KBM803 (above all, Shin-Etsu Silicone Inc.) and the like.

### EXAMPLES

A specific example of the bonding composition that can be used for the connecting method according to the present invention is illustrated in detail.

### Preparation of Example and Comparative Example Compositions

Materials except peroxide shown in Table 1 were completely dissolved and mixed under a condition with heating, which was then cooled to room temperature and the peroxide was added, and the composition was further stirred, mixed and defoamed in vacuum.

### Measurement of Viscosity

By using the HAAKE PK1-type viscometer, the viscosity at 25° C. was measured.

### Measurement of Photo-Curing Property

A sample from the example or comparative example was applied on one side of a slide glass (76×26×1 mm), and another slide glass was laminated in a direction of 90°, followed by irradiation for 1 second at an illuminance of 100 mW/cm² by using a high-pressure mercury lamp. Two slide glasses were attempted to displace with fingers, and the fixation time was determined as a time when these slide glasses became difficult to displace.

### Measurement of Anaerobic Curing Property

A sample from the example or comparative example was applied on an edge of one side of a lap-shear test piece (made of copper; 100×25×1.6 mm), and another test piece was laminated from opposite direction so that they were overlapped in 12.5 mm, which was fixed with a clamp. At constant time intervals, the clamp was removed and a weight of about 3 kg was loaded, and the fixation time was determined as a time when displacement does not occur any more.

TABLE 1

| | Example 1 | Comparative |
|---|---|---|
| Composition | (%) | example 1 (%) |
| 2-Hydroxyethyl methacrylate | 7.2 | 7.2 |
| Ebecryl 230*¹⁾ | 83.7 | 83.7 |
| Acrylic acid | 2.3 | 2.3 |
| Saccharin | 1.0 | — |
| Ethylenediamine | Trace | — |
| | amount | |
| Irgacure 651*²⁾ | 1.8 | 2.8 |
| Irgacure 184*³⁾ | 2.0 | 4.0 |
| Lucirin TPO*⁴⁾ | 1.0 | — |
| Cumene hydroperoxide | 1.0 | — |
| Viscosity, mPas/25° C. | 16500 | 17000 |
| Photo-curing property | | |
| Fixation time, second | 1 | 1 |
| Illuminance: 100 mW/cm² | | |
| High-pressure mercury lamp | | |
| Anaerobic curing property | | |
| Fixation time, minute | 15 | not cured |

*¹⁾Urethane-modified acrylate, supplied by Daicel-Cytec Company Ltd.
*²⁾Photo initiator (UV region), supplied by Ciba Specialty Chemicals, 2,2-dimethoxy-1,2-diphenylethan-1-one.
*³⁾Photo initiator (UV region), supplied by Ciba Specialty Chemicals, 1-hydroxy-cyclohexyl-phenyl-ketone.
*³⁾Photo initiator (Visible region), supplied by BASF Corporation, 2,4,6-trimethylbenzoyl-phosphine oxide.

According to Table 1, the composition of the comparative example 1 is photo-curable but does not have the anaerobic curing function. Therefore, it is obvious that the use of the composition of the comparative example 1 for the connecting method according to the present invention is less reliable in connecting. In contrast, it is obvious that the composition of the example 1 is curable with light irradiation, and the composition can be preferably used for the present invention.

A wide variety of modifications may be possible unless departing from the spirit of the present invention. Therefore, the embodiments illustrated here are examples, and they do not restrict the range of the present invention described in the scope of claims.

### INDUSTRIAL APPLICABILITY

According to the present invention, the connection of an electrode of flat displays such as liquid crystal displays and a flexible substrate and the like can be conducted by a simple process with excellent reliability.

1. A method for adhering of a first connecting portion comprising a first electrode formed on a transparent substrate and a second connecting portion comprising a second electrode formed on a flexible substrate, whereby electrically connecting the first electrode and the second electrode, the method comprising the steps of:
applying a bonding composition on at least one of the first connecting portion and the second connecting portion;
aligning the first electrode and the second electrode, and irradiating with light while the first connecting portion and the second connecting portion are pressed so as to contact each other; and
allowing the resulting assembly to stand at ambient temperature after the light irradiation; wherein
the bonding composition comprises no electrically-conductive particle, but comprises:
(a) a curable resin component;
(b) a photo cure initiation component; and
(c) an anaerobic curing initiation component;
and wherein the anaerobic curing is not completed when the photo-irradiation is terminated.

2. A method according to claim 1, wherein the photo cure initiation component (b) is a photo radical generator.

3. A method according to claim 1, wherein the photo-irradiation comprises a wavelength of a visible light range, and the photo cure initiation component (b) comprises a visible-light-radical generator which generates a radical by a photo-irradiation of a visible light range.

4. A method according to claim 3, wherein the photo-irradiation comprises a wavelength of a visible light range from 400 to 550 nm, and the photo cure initiation component (b) comprises a visible-light radical generator which generates a radical by a photo-irradiation of this range of wavelength.

5. A method according to claim 1, wherein the curable resin component (a) comprises a (meth)acrylic monomer and/or a (meth)acrylate oligomer.

6. A bonding composition used for the method according to claim 1, wherein the bonding composition comprises no electrically-conductive particle, but comprises:
(a) a curable resin component;
(b) a photo cure initiation component; and
(c) an anaerobic curing initiation component;
wherein the bonding composition is prepared so that a anaerobic curing time is longer than a photo-curing time.
